(19) United States
(12) Patent Application Publication
(10) Pub. No.: US 2026/0038171 A1
(43) Pub. Date: Feb. 5, 2026

(54) SYSTEMS AND METHODS OF IMAGE EDITING BASED ON MULTIMODAL LARGE LANGUAGE MODELS

(71) Applicant: Samsung Electronics Co., Ltd., Suwon-si (KR)

(72) Inventors: Hyunseung KIM, San Jose, CA (US); Srikanth MALLA, Fremont, CA (US); Sai Prahladh PADMANABHAN, San Jose, CA (US); Chiho CHOI, San Jose, CA (US); Joon Hee CHOI, Campbell, CA (US)

(21) Appl. No.: 18/939,499

(22) Filed: Nov. 6, 2024

Related U.S. Application Data
(60) Provisional application No. 63/679,597, filed on Aug. 5, 2024.

(51) Int. Cl. G06T 11/60; G06F 16/54; G06F 40/284; G06F 40/40

(52) U.S. Cl. CPC G06T 11/60; G06F 16/54; G06F 40/284; G06F 40/40

(57) ABSTRACT

Provided are systems, methods, and apparatuses for systems and methods of image editing based on multimodal large language models. In one or more examples, the systems, devices, and methods include generating image tokens from an input image and word tokens from an editing prompt; generating a mask token based on an artificial intelligence model processing the image tokens and the word tokens; and generating an editing mask based on a mask decoder processing the mask token, word embeddings of the editing prompt, and visual embeddings of the input image. In one or more examples, the systems, devices, and methods include generating a correlation map that correlates the editing mask to a set of one or more words of the editing prompt; and generating an output image based on the correlation map, the output image comprising an edited version of the input image according to the editing prompt.

### CROSS-REFERENCE TO RELATED APPLICATIONS

This application claims the benefit of U.S. Provisional Patent Application Ser. No. 63/679,597, filed Aug. 5, 2024, which is incorporated by reference herein for all purposes.

### TECHNICAL FIELD

The subject matter disclosed here relates to memory systems. In particular, the subject matter relates to systems and methods of image editing based on multimodal large language models, including generating relatively precise editing masks for input into generative artificial intelligence models.

### BACKGROUND

The present background section is intended to provide context only, and the disclosure of any concept in this section does not constitute an admission that said concept is prior art.

Artificial intelligence (AI) workloads demand memory and storage solutions that provide high throughput and low latency to accommodate rapid processing of relatively large datasets. High throughput memory/storage ensures data can be read and written quickly. Low latency memory/storage provides quick data access for real-time AI applications. However, the proliferation of AI has resulted in a rapid increase in demands for improvements in data movement bandwidths and data storage capacity, which has left data centers and related devices struggling to keep up with demand.

### SUMMARY

In various embodiments, the systems and methods described herein include systems, methods, and apparatuses for image editing based on multimodal large language models. In some aspects, the techniques described herein relate to a method of image editing including: generating image tokens from an input image and word tokens from an editing prompt; generating a mask token based on an artificial intelligence model processing the image tokens and the word tokens; generating an editing mask based on a mask decoder processing the mask token, word embeddings of the editing prompt, and visual embeddings of the input image; generating a correlation map that correlates the editing mask to a set of one or more words of the editing prompt; and generating an output image based on the correlation map, the output image including an edited version of the input image according to the editing prompt.

In some aspects, the techniques described herein relate to a method, wherein the mask token is generated based on the artificial intelligence model determining the set of one or more words of the editing prompt are applicable to the input image based on at least one of the image tokens correlating to at least one of the word tokens.

In some aspects, the techniques described herein relate to a method, wherein generating the editing mask is based on feeding the word embeddings to a first transformer decoder layer of the mask decoder and feeding the visual embeddings to a second transformer decoder layer of the mask decoder, the mask decoder being trained to generate the editing mask based on the mask decoder processing the mask token, word embeddings of the editing prompt, and visual embeddings of the input image.

In some aspects, the techniques described herein relate to a method, wherein generating the correlation map is based on matrix multiplication between the mask token and the word embeddings.

In some aspects, the techniques described herein relate to a method, further including generating a negative token based on the artificial intelligence model processing the image tokens and the word tokens.

In some aspects, the techniques described herein relate to a method, wherein the negative token is generated based on the artificial intelligence model determining a second set of one or more words of the editing prompt are not applicable to the input image based on matrix multiplication between the negative token and the word embeddings.

In some aspects, the techniques described herein relate to a method, further including generating a black mask based on the mask decoder processing the negative token, the word embeddings of the editing prompt, and the visual embeddings of the input image.

In some aspects, the techniques described herein relate to a method, wherein: the correlation map correlates the black mask to the second set of one or more words of the editing prompt, and applying the black mask results in no changes to the input image.

In some aspects, the techniques described herein relate to a method, wherein a word embedder generates the word embeddings from the editing prompt and a visual encoder generates the visual embeddings from the input image.

In some aspects, the techniques described herein relate to a method, wherein a diffusion model generates the output image based on the diffusion model processing the correlation map, the input image, and the editing prompt.

In some aspects, the techniques described herein relate to a method, wherein the artificial intelligence model includes a multimodal large language model.

In some aspects, the techniques described herein relate to a device including: one or more processors; and memory storing instructions that, when executed by the one or more processors, cause the device to: generate image tokens from an input image and word tokens from an editing prompt; generate a mask token based on an artificial intelligence model processing the image tokens and the word tokens; generate an editing mask based on a mask decoder processing the mask token, word embeddings of the editing prompt, and visual embeddings of the input image; generate a correlation map that correlates the editing mask to a set of one or more words of the editing prompt; and generate an output image based on the correlation map, the output image including an edited version of the input image according to the editing prompt.

In some aspects, the techniques described herein relate to a device, wherein the mask token is generated based on the artificial intelligence model determining the set of one or more words of the editing prompt are applicable to the input image based on at least one of the image tokens correlating to at least one of the word tokens.

In some aspects, the techniques described herein relate to a device, wherein generating the editing mask is based on feeding the word embeddings to a first transformer decoder layer of the mask decoder and feeding the visual embeddings to a second transformer decoder layer of the mask decoder, the mask decoder being trained to generate the editing mask based on the mask decoder processing the mask token, word embeddings of the editing prompt, and visual embeddings of the input image.

In some aspects, the techniques described herein relate to a device, wherein generating the correlation map is based on matrix multiplication between the mask token and the word embeddings.

In some aspects, the techniques described herein relate to a device, wherein the instructions, when executed by the one or more processors, further cause the device to generate a negative token based on the artificial intelligence model processing the image tokens and the word tokens, the negative token being generated based on the artificial intelligence model determining a second set of one or more words of the editing prompt are not applicable to the input image based on matrix multiplication between the negative token and the word embeddings.

In some aspects, the techniques described herein relate to a device, wherein the instructions, when executed by the one or more processors, further cause the device to generate a black mask based on the mask decoder processing the negative token, the word embeddings of the editing prompt, and the visual embeddings of the input image.

In some aspects, the techniques described herein relate to a non-transitory computer-readable medium storing code that includes instructions executable by a processor to: generate image tokens from an input image and word tokens from an editing prompt; generate a mask token based on an artificial intelligence model processing the image tokens and the word tokens; generate an editing mask based on a mask decoder processing the mask token, word embeddings of the editing prompt, and visual embeddings of the input image; generate a correlation map that correlates the editing mask to a set of one or more words of the editing prompt; and generate an output image based on the correlation map, the output image including an edited version of the input image according to the editing prompt.

In some aspects, the techniques described herein relate to a non-transitory computer-readable medium, wherein the mask token is generated based on the artificial intelligence model determining the set of one or more words of the editing prompt are applicable to the input image based on at least one of the image tokens correlating to at least one of the word tokens.

In some aspects, the techniques described herein relate to a non-transitory computer-readable medium, wherein generating the editing mask is based on feeding the word embeddings to a first transformer decoder layer of the mask decoder and feeding the visual embeddings to a second transformer decoder layer of the mask decoder, the mask decoder being trained to generate the editing mask based on the mask decoder processing the mask token, word embeddings of the editing prompt, and visual embeddings of the input image.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

The systems and methods of image editing based on multimodal large language models described herein include multiple advantages and benefits. For example, the systems and methods minimize or eliminate preprocessing that is performed by other systems. For instance, the systems and methods minimize or eliminate defining keyword objects for an instruction (e.g., for each instruction and/or separate single instruction). Also, the systems and methods identify relatively precise editing regions. Some cross-attention maps focus on the object locations. The systems and methods identify regions of an image specified in an editing prompt, resulting in more accurate and targeted modifications. Also, the systems and methods provide handling for non-applicable instructions in an editing prompt (e.g., instructions that do not apply to any identifiable object in the input image). The systems and methods are configured to distinguish non-applicable image editing instructions based on a trained multimodal large language model (MLLM), resulting in improved image editing quality by preventing issues with over-editing and filtering out non-applicable editing instructions. Also, the systems and methods may process multi-instruction inputs in a single pass based on instruction-based MLLM tokens (e.g., mask tokens for applicable instructions, negative tokens (neg tokens) for non-applicable instructions).

### BRIEF DESCRIPTION OF THE DRAWINGS

The above-mentioned aspects and other aspects of the present systems and methods will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings wherein:

FIG. 1 illustrates an example system in accordance with one or more implementations as described herein.

FIG. 2 illustrates details of the system of FIG. 1, according to one or more implementations as described herein.

FIG. 3 illustrates an example system in accordance with one or more implementations as described herein.

FIG. 4 illustrates an example system in accordance with one or more implementations as described herein.

FIG. 5 illustrates an example system in accordance with one or more implementations as described herein.

FIG. 6 illustrates an example system in accordance with one or more implementations as described herein.

FIG. 7 illustrates an example system in accordance with one or more implementations as described herein.

FIG. 8 depicts a flow diagram illustrating an example method associated with the disclosed systems, in accordance with example implementations described herein.

FIG. 9 depicts a flow diagram illustrating an example method associated with the disclosed systems, in accordance with example implementations described herein.

FIG. 10 depicts a flow diagram illustrating an example method associated with the disclosed systems, in accordance with example implementations described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially, such that one instruction is retrieved, loaded, and executed at a time. In some example embodiments, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on chip (SoC), an assembly, and so forth.

The following description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

It is noted that, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Data processing may include data buffering, aligning incoming data from multiple communication lanes, forward error correction (FEC), etc. For example, data may be received by an analog front end (AFE), which can prepare the incoming data for digital processing. The digital portion of the transceivers (e.g., digital signal processor (DSP)) may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, SoC, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

The systems and methods described herein may be based on and/or may include artificial intelligence (AI). AI can include the concept of creating intelligent machines that can sense, reason, act, and adapt. Machine learning (ML) may be a subset of AI that helps build AI-driven applications. The systems and methods described make be based on AI programs that use Large Language Models (LLMs). In some cases, LLMs may be based on editing prompts. A given editing prompt may be split into portions (e.g., textual components) of the whole editing prompt.

The systems and methods described herein may be based on and/or may include LLMs that use deep learning to analyze and generate content based on large amounts of data. LLMs can perform a variety of tasks, including text generation, summarization, translation, question answering, creative writing, code generation, chatbots, virtual assistants, etc. Deep learning can be a subset of machine learning that uses artificial neural networks to mimic the learning process of the human brain.

The systems and methods described herein may be based on and/or may include deep learning algorithms. Deep learning algorithms can use large amounts of data and complex algorithms to train a model. Neural networks can be the foundation of deep learning algorithms. In machine learning, AI inference can include the process of using a trained model to make predictions. In some cases, AI training can be typically a first step in a two-part process of machine learning. Inference can be faster than training because inference does not include the model adjusting its parameters based on new data. Inference also uses less processing power than training clusters. AI can include AI interference delegation. AI inference delegation techniques provide scalable memory bandwidth and scalable memory capacity to accommodate increased query lengths and increased number of concurrent users.

The systems and methods described herein may be based on and/or may include attention mechanisms. Attention mechanisms allow models to assign different weights to different parts of data, instead of treating all data equally. Attention mechanisms can enable an AI model to focus on the most relevant parts of the input, which can help the AI model understand and generate human-like text. For example, in machine translation, attention can help an AI model focus on the first word to translate, and then use that output to determine the next word to focus on, and so on.

The systems and methods described herein may be based on and/or may include vectors and/or embeddings (e.g., vector embeddings). A vector may be an array of numbers representing data points in a high-dimensional space, while an embedding may include a contextual vector where the vector arrangement of the embedding captures contextual relationships and/or semantic information about the input data. Thus, embeddings may be a more structured and/or contextually relevant representation of data, where an embedding represents data (e.g., words, images, concepts) as vectors in a way that encodes meaningful relationships between data points, which may be learned through a machine learning model.

The systems and methods described herein may be based on and/or may include text tokenizers. A text tokenizer may include tools that breaks down text (e.g., words, numbers, or punctuation) into individual parts, called tokens, to help machines understand human language. In some cases, tokens generated from input text may include vector representations of the text, where the vectors are based on a given tokenizer. Thus, tokenization can turn unstructured text into a numerical data structure that machines can use to recognize patterns, understand context, and generate responses. There are multiple ways to tokenize text, including word, character, and subword tokenizers. For example, Byte Pair Encoding (BPE) is a widely used subword tokenizer that segments out-of-vocabulary (OOV) words as subwords.

The systems and methods described herein may be based on and/or may include using convolutional neural networks (CNNs) and/or vision transformers (ViTs) for image processing. ViTs can include AI transformers designed for computer vision. A ViT can break down an input image into a series of patches, serialize each patch into a vector, and map it to a smaller dimension with a single matrix multiplication. These vectors can then be processed by a transformer encoder. Compared to CNNs, a ViT may be less data efficient, but have higher capacity. In some cases, vision transformer processing can include splitting the image into image patches and processing patches through a linear projection layer to get initial patch embeddings. For example, after building the image patches, a linear projection layer may be used to map the image patch arrays to patch embedding vectors (e.g., linearly projected to obtain a fixed-size embedding vector for each patch). The linear projection layer transforms arrays into vectors while maintaining their physical dimensions, meaning similar image patches may be mapped to similar patch embeddings. Vision transformer processing can include preappending trainable “class” embedding to patch embeddings and summing patch embeddings and learned positional embeddings. It is noted that image patches may be individual segments of an image. Image embeddings may be numerical representations of image patches that help AI models capture visual meaning in a vector space.

The systems and methods described herein may be based on and/or may include vision encoders. Vision encoders may undergo training through a process of minimizing the disparity between the vector representations of images and their corresponding text descriptions. Both images and texts may be converted into numerical embeddings, or compact representations in a vector space.

The systems and methods described herein may be based on and/or may include projection layers. Projection layers may map input features into a new representation that may be more suitable for subsequent tasks or layers. Projection can increase the dimensionality to capture more complex patterns and/or reduce the dimensionality to compress the data and reduce noise. Projection layers may use a linear transformation with a projection matrix to streamline computations within a model without significantly impacting performance. Projection layers may be implemented using matrix multiplication where the matrix (projection matrix) is learned during training, deciding which aspects of data to focus on. Projection layers may be used in convolutional neural networks (CNNs) for image classification and object detection, where they may be used to reduce the number of channels after a convolutional layer. After extracting features from an image through convolutional layers, a projection layer may be applied to reduce the feature dimension before feeding it to a fully connected layer. For image analysis, projection layers may be used to project different parts of the image representation into a common space before applying the attention mechanism.

The systems and methods described herein may be based on and/or may include text tokenizers. Text tokenizer may include tools that breaks down text into smaller units, called tokens, to help machines understand human language. Tokenization can include a preprocessing step in Natural Language Processing (NLP) that breaks down text into tokens, which can be words, phrases, characters, etc.

The systems and methods described herein may be based on and/or may include editing masks. In some cases, the systems and methods may include generating one or more editing masks. In some cases, an editing mask may be generated from word embeddings, which may be based on calculating the similarity between a target word embedding and the embeddings of each word in the text prompt (e.g., editing prompt), using a similarity metric like cosine distance (e.g., for each word in the text, compute its cosine similarity with the target word embedding), and then implementing a threshold on the resulting similarity scores to create a mask where relatively high similarity indicates a potential editing area of the editing mask and relatively low similarity indicates a potential masked area of the editing mask. For example, words with relatively high similarity to the target word (e.g., objects in an image correlated to words with relatively high similarity) may be marked as editable within the mask. In some cases, a threshold value may be set and a binary mask may be created where values above the threshold are marked as 1 (e.g., indicating potential edit locations) and values below are marked as 0. In some cases, incorporating context-aware embeddings or attention mechanisms can provide more nuanced editing masks by considering contextual information of surrounding words. In some cases, the mask generation process may include encoding an input image into a latent space (e.g., visual embeddings), manipulating the embeddings based on a text prompt describing the desired edit, and finally decoding the modified embeddings to produce a mask highlighting one or more areas to be edited within the original image. The process may include inpainting where the mask is used to specify regions where new content should be generated. In some cases, the modified embedding may be decoded to generate a mask image. This mask may include pixel values representing the areas that should be edited, with relatively high values indicating the region of interest. The mask generation process may include generating a mask around an object you want to remove from an image; creating a mask to isolate the foreground subject for seamless background replacement; and/or applying a mask to selectively transfer the style of one image onto another.

The systems and methods described herein may be based on and/or may include a mask decoder. A mask decoder may include one or more transformer decoder layers. An encoder may receive text and/or an image an input and generate an encoded version of the text and/or image (e.g., a text token, image token, word embedding, visual embedding). A decoder may receive encoded data (e.g., a text token, image token, word embedding, visual embedding) and generate text and/or an image as an output. In some cases, the output of the decoder may include editing masks. The output of an encoder layer may include a set of vectors, each representing an input sequence with rich contextual associations. This output may then be used as the input for a decoder in a Transformer model. The encoding paves the way for the decoder, guiding the decoder to pay attention to the right words from input text and/or objects from an input image when the time to decode arrives. This can be thought of like building a tower, where N encoder layers are stacked up. Each layer in this stack gets a chance to explore and learn different facets of attention, much like layers of knowledge. This diversifies the understanding and can significantly amplify the predictive capabilities of the transformer network. The decoder's role includes crafting text sequences and/or images (e.g., objects in images). Mirroring the encoder, the decoder may be equipped with a similar set of sub-layers. A decoder may include a number of multi-headed attention layers, a pointwise feed-forward layer, and incorporate both residual connections and layer normalization after each sub-layer. Accordingly, an encoder may be trained to receive an image and/or text as input and generate vector representations of the words of the text and/or objects from the image. A decoder may be trained to receive vector representations of words of text and/or vector representations of objects from an image and generate text (e.g., a sequence of words) and/or an image (e.g., objects of an image) from the vector representations. In some cases, the output of the decoder may be based on a query (e.g., editing prompt), and the processing of the decoder output (e.g., editing mask) in relation to the query may result in an output image that is an edited version of an input image.

The systems and methods described herein may be based on and/or may include diffusion models. A diffusion model can include machine learning algorithms that use a process of adding noise to data (e.g., image, audio, etc.) and then learning to reverse the noise to create the original data or new data (e.g., modified data). A diffusion model can gradually degrade the quality of the data, and then reconstruct the data to its original form or transforms the data into something new. This process allows the model to learn to create synthetic data that is similar to the original dataset.

The systems and methods described herein may be based on and/or may include cross-attention control. Cross-attention control can modify the internal attention maps of the diffusion model during inference to allow for image inversion and cross-attention enabled prompt editing. For example, cross-attention control can be used to reconstruct an image using a prompt, or replace a target with a prompt. Cross-attention maps can also serve as the weight of the corresponding token on the corresponding pixel, and contain the characteristic information of the token.

The systems and methods described herein may be based on and/or may include a neural processing unit (NPU). NPUs can include a specialized processor that executes machine learning algorithms. NPUs are also called AI accelerators or intelligent processing units (IPUs). NPUs improve the inference performance of neural networks. NPUs work similarly to the human brain. They are made up of nerve cells and synapses that transmit and receive signals to and from each other. NPUs use a data-driven parallel computing architecture to process large amounts of multimedia data, like images and videos. NPUs may be used to offload specific workloads, allowing dedicated hardware to focus on more specialized tasks.

The systems and methods described herein may be based on and/or may include High Bandwidth Memory (HBM). HBM can include a type of memory architecture used in high-performance computing applications that requires fast data transfer speeds. HBM uses 3D stacking technology to pack more memory chips into a smaller space, which reduces the distance data needs to travel between the processor and memory. This results in higher bandwidth, which allows for faster data transfer, and lower power consumption, which can help extend battery life.

The systems and methods described herein may be based on and/or may include Compute Express Link (CXL) memory. CXL memory can include memory with a high-speed interface that allows for communication between devices such as processors, memory, accelerators, storage, and other IO devices. CXL memory can be designed for high-performance data center computers and may use a Peripheral Component Interconnect Express (PCIe) physical and/or electrical interface.

Some image editing models based on generative AI architectures (e.g., Generative Pre-trained Transformers (GPT) models) may use text encoders (e.g., Contrastive Language-Image Pretraining (CLIP) text encoders) that exhibit limited capabilities in comprehending relatively complex editing prompts compared to large language models (LLMs). Some instruction-guided models with multimodal LLMs can struggle with multi-instruction and/or non-applicable editing prompts. While some instruction-guided image editing models may incorporate multimodal LLMs, some models may continue to demonstrate suboptimal performance in handling multi-instruction and/or non-applicable editing prompts. For example, some multimodal LLM-based image editing models tend to interpret non-applicable instruction literally, which can lead to over-editing by users and/or inaccurate results generated by the AI models.

Some multi-instruction-based image editing systems may use cross-attention maps from generative AI models for a mask, but such systems may lack granularity and/or accuracy. The cross-attention maps often attend to unimportant areas rather than more applicable regions for editing. In some cases, such models tend to attend to whole objects rather than specified regions for editing. For instance, when instructed to place an object adjacent to another, the cross-attention map of such systems may indicate the existing object instead of the intended region of modification.

Some image editing models may implement imprecise attention masks that lack accuracy for fine-grained-editing and/or result in unintended modifications. Some image editing models may implement external preprocessing that depends on a distinction between instructions and keyword extraction by some Generative Pre-trained Transformers (GPT) models. Some image editing models may include object-centric attention that focuses more on an entire object rather than a region specified for editing. As a result, some LLM-based image editing models exhibit suboptimal performance in handling multi-instructions or non-applicable editing prompts.

The systems and methods described herein provide an image editing mechanism that leverages multimodal large language models (MLLMs) to generate editing masks for input into generative AI models. The systems and methods include AI image editing tokens (e.g., mask token, neg token) to enhance the generative AI model's capability in distinguishing non-applicable instructions and efficiently handling multi-instruction scenarios.

In some examples, a mask token may be a vector representation of an editing mask (e.g., based on an instruction that is determined to be applicable to the image). In some cases, a negative token may be a vector representation of a black mask or blank mask (e.g., based on an instruction that is determined to be non-applicable to the image). A black mask may mask an entire image. When a black mask is applied to an image, the black mask may mask or cover the entire image, resulting in nothing in the image being edited or modified. Unlike a black mask, an editing mask may mask portions of an image. When an editing mask is applied to an image, the editing mask may mask or cover one or more portions of the image and leave one or more other portions unmasked, resulting in the one or more unmasked portions of the image being edited or modified and the masked portions remaining unchanged.

The systems and methods described herein provide a token broadcasting module that distributes a generated mask (e.g., automatically distributes each generated mask) from the MLLM and mask decoder to a corresponding editing prompt token. The systems and methods incorporate a MLLM to decipher and process both applicable and non-applicable instructions, including multi-instructions (e.g., two or more sets of instructions in an editing prompt) for image editing tasks.

The systems and methods introduce two types of masks for MLLM, denoted by mask token and neg token, corresponding to each instruction in the input prompt. For applicable instructions, the AI model may be configured to generate mask tokens that are subsequently decoded into binary editing masks compatible with a generative AI network. Additionally, or alternatively, the AI model may generate a negative token (neg token) for non-applicable instructions. For example, the AI model may be configured to identify and segregate editing prompts that should not be executed on the image. Editing prompts may be referred to as text input, textual instructions, etc.

The systems and methods described herein implement a token broadcasting module that distributes (e.g., automatically distributes) the generated mask to their corresponding word tokens. For example, the systems and methods may include mapping a first portion of an editing prompt to a mask token and mapping a second portion of the editing prompt to a neg token, etc. The systems and methods ensure a precise alignment between textual components (e.g., portions) of the editing prompt and the respective region of influence in the image.

The system and methods may include and/or may be based on at least one of: training a multimodal large language model (MLLM); analyzing, by the MLLM, an input image in relation to an editing prompt; generating a mask token based on the analyzing of the input image in relation to the editing prompt; generating a neg token based on the analyzing of the input image in relation to the editing prompt; generating, by a mask decoder, an editing mask based on the mask token; generating a black mask based on the neg token; generating, by a mask broadcaster, at least one correlation map (e.g., broadcasted mask) based on the mask broadcaster analyzing at least one of the editing mask or the black mask; generating an output image based on a generative AI model analyzing the at least one broadcasting mask; and/or process the multi-instruction input in a single pass based on the mask token and/or the neg token. The editing prompt may include a multi-instruction input.

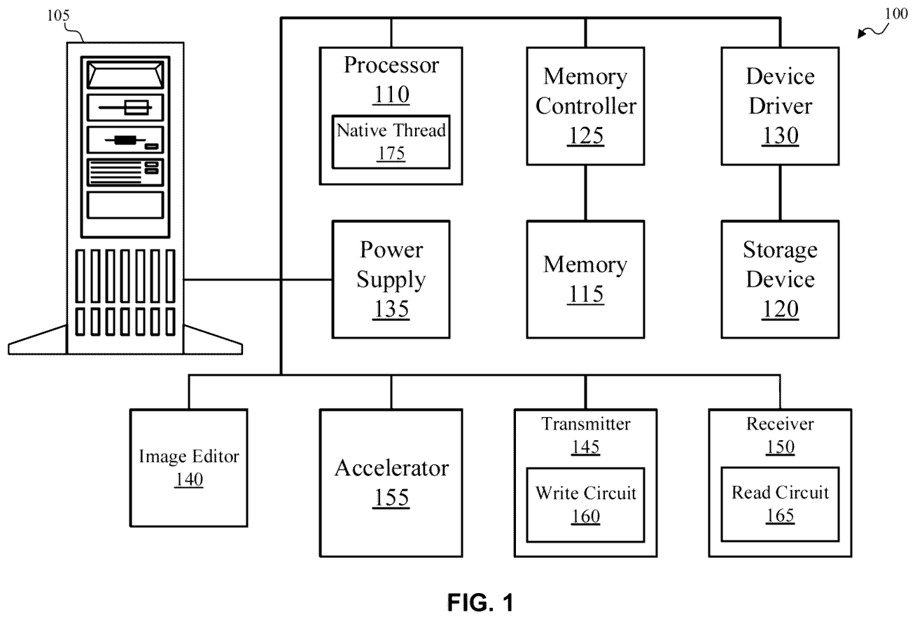

FIG. 1 illustrates an example system 100 in accordance with one or more implementations as described herein. In FIG. 1, machine 105, which may be termed a host, a system, or a server, is shown. While FIG. 1 depicts machine 105 as a tower computer, embodiments of the disclosure may extend to any form factor or type of machine. For example, machine 105 may be a rack server, a blade server, a desktop computer, a tower computer, a mini tower computer, a desktop server, a laptop computer, a notebook computer, a tablet computer, etc.

Machine 105 may include processor 110, memory 115, and storage device 120. Processor 110 may be any variety of processor. It is noted that processor 110, along with the other components discussed below, are shown outside the machine for case of illustration: embodiments of the disclosure may include these components within the machine. While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM), Phase Change Memory (PCM), or Resistive Random-Access Memory (ReRAM). Memory 115 may include volatile and/or non-volatile memory. Memory 115 may use any desired form factor: for example, Single In-Line Memory Module (SIMM), Dual In-Line Memory Module (DIMM), Non-Volatile DIMM (NVDIMM), etc. Memory 115 may be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may support an operating system under which various applications may be running. These applications may issue requests (which may be termed commands) to read data from or write data to either memory 115 or storage device 120. When storage device 120 is used to support applications reading or writing data via some sort of file system, storage device 120 may be accessed using device driver 130. While FIG. 1 shows one storage device 120, there may be any number (one or more) of storage devices in machine 105. Storage device 120 may support any desired protocol or protocols, including, for example, the Non-Volatile Memory Express (NVMe) protocol, a Serial Attached Small Computer System Interface (SCSI) (SAS) protocol, or a Serial AT Attachment (SATA) protocol. Storage device 120 may include any desired interface, including, for example, a Peripheral Component Interconnect Express (PCIe) interface, or a Compute Express Link (CXL) interface. Storage device 120 may take any desired form factor, including, for example, a U.2 form factor, a U.3 form factor, a M.2 form factor, Enterprise and Data Center Standard Form Factor (EDSFF) (including all of its varieties, such as E1 short, E1 long, and the E3 varieties), or an Add-In Card (AIC).

While FIG. 1 uses the term “storage device,” embodiments of the disclosure may include any storage device formats that may benefit from the use of computational storage units, examples of which may include hard disk drives, Solid State Drives (SSDs), or persistent memory devices, such as PCM, ReRAM, or MRAM. Any reference to “storage device” “SSD” below should be understood to include such other embodiments of the disclosure and other varieties of storage devices. In some cases, the term “storage unit” may encompass storage device 120 and memory 115. Machine 105 may include power supply 135. Power supply 135 may provide power to machine 105 and its components.

Machine 105 may include transmitter 145 and receiver 150. Transmitter 145 or receiver 150 may be respectively used to transmit or receive data. In some cases, transmitter 145 and/or receiver 150 may be used to communicate with memory 115 and/or storage device 120. Transmitter 145 may include write circuit 160, which may be used to write data into storage, such as a register, in memory 115 and/or storage device 120. In a similar manner, receiver 150 may include read circuit 165, which may be used to read data from storage, such as a register, from memory 115 and/or storage device 120.

In the illustrated example, machine 105 may include accelerator 155, which may be used to perform one or more operations described herein (e.g., AI-based image editing). In some cases, image editor 140 may implement or incorporate at least a portion of accelerator 155 to perform one or more operations described herein.

In one or more examples, machine 105 may be implemented with any type of apparatus. Machine 105 may be configured as (e.g., as a host of) one or more of a server such as a compute server, a storage server, storage node, a network server, a supercomputer, data center system, and/or the like, or any combination thereof. Additionally, or alternatively, machine 105 may be configured as (e.g., as a host of) one or more of a computer such as a workstation, a personal computer, a tablet, a smartphone, and/or the like, or any combination thereof. Machine 105 may be implemented with any type of apparatus that may be configured as a device including, for example, an accelerator device, a storage device, a network device, a memory expansion and/or buffer device, a central processing unit (CPU), a graphics processing unit (GPU), a neural processing unit (NPU), a tensor processing unit (TPU), optical processing units (OPU), and/or the like, or any combination thereof.

Any communication between devices including machine 105 (e.g., host, computational storage device, and/or any intermediary device) can occur over an interface that may be implemented with any type of wired and/or wireless communication medium, interface, protocol, and/or the like including PCIc, NVMe, Ethernet, NVMe-oF, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), Advanced extensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, system 100 may include one or more additional apparatus having one or more additional communication interfaces.

Any of the functionality described herein, including any of the host functionality, device functionally, image editor 140 functionality, and/or the like, may be implemented with hardware, software, firmware, or any combination thereof including, for example, hardware and/or software combinational logic, sequential logic, timers, counters, registers, state machines, volatile memories such as at least one of or any combination of the following: dynamic random access memory (DRAM) and/or static random access memory (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application specific integrated circuits (ASICs) CPUs including complex instruction set computer (CISC) processors such as x86 processors and/or reduced instruction set computer (RISC) processors such as RISC-V and/or ARM processors), GPUs, NPUs, TPUs, OPUs, and/or the like, executing instructions stored in any type of memory. In some embodiments, one or more components of image editor 140 may be implemented as an SoC.

In some examples, image editor 140 may include any one or combination of logic (e.g., logical circuit), hardware (e.g., processing unit, memory, storage), software, firmware, and the like. In some cases, image editor 140 may perform one or more functions in conjunction with processor 110. In some cases, at least a portion of image editor 140 may be implemented in or by processor 110 and/or memory 115. The one or more logic circuits of image editor 140 may include any one or combination of multiplexers, registers, logic gates, arithmetic logic units (ALUs), cache, computer memory, microprocessors, processing units (CPUs, GPUs, NPUs, and/or TPUs), FPGAS, ASICs, etc., that enable image editor 140 to provide systems and methods of image editing based on multimodal large language models.

In one or more examples, image editor 140 may provide image editing based on multimodal large language models. For example, image editor 140 may minimize or eliminate preprocessing that is performed by other systems. For instance, image editor 140 may minimize or eliminate defining keyword objects for an instruction (e.g., for each instruction and/or separate single instruction). Also, image editor 140 may identify relatively precise editing regions. Some cross-attention maps focus on the object locations. Image editor 140 may identify regions of an image specified in an editing prompt, resulting in more accurate and targeted modifications. Also, image editor 140 may provide handling for non-applicable instructions in an editing prompt (e.g., instructions that do not apply to any identifiable object in the input image). Image editor 140 may be configured to distinguish non-applicable image editing instructions based on a trained multimodal large language model (MLLM), resulting in improved image editing quality by preventing issues with over-editing and filtering out non-applicable editing instructions. Also, image editor 140 may process multi-instruction inputs in a single pass based on instruction-based MLLM tokens (e.g., mask tokens for applicable instructions, negative tokens (neg tokens) for non-applicable instructions).

The techniques described herein include logic (e.g., image editor 140) to provide systems and methods of image editing based on multimodal large language models. The logic includes any combination of hardware (e.g., at least one memory, at least one processor), logical circuitry, firmware, and/or software to provide systems and methods of image editing based on multimodal large language models.

The systems and methods enhance comprehension of complex editing instructions, including multi-instruction and/or non-applicable editing prompts. The systems and methods may be based on a multimodal LLM (MLLM), a Mask Decoder, and/or a Mask Broadcaster. The systems and methods may include generating accurate masks for regions specified for modification in editing prompts. For example, the systems and methods may implement MLLM token mechanisms where the MLLM is trained to generate one or more mask tokens based on identifying applicable instructions from the editing prompt and/or generate one or more neg tokens based on identifying non-applicable instructions from the editing prompt. In some cases, a Mask Decoder may receive a mask token and generate an editing mask for an editing prompt (e.g., an applicable portion of the editing prompt linked to that mask token), while a neg token may identify a non-applicable instruction (e.g., a portion of the editing prompt that is non-applicable to the input image). In some cases, a mask token may be decoded into a binary format mask for input to a generative AI model.

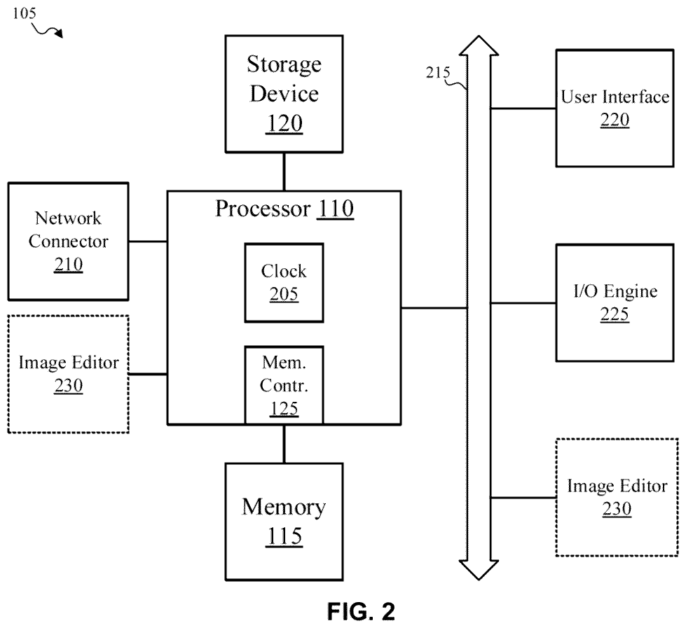

FIG. 2 illustrates details of machine 105 of FIG. 1, according to examples described herein. In the illustrated example, machine 105 may include processor 110. Processor 110 may include one or more processors and/or one or more dies. Processor 110 may include memory controller 125 (e.g., one or more memory controllers) and clock 205 (e.g. one or more clocks), which may be used to coordinate the operations of the components of the machine. Processor 110 may be coupled to memory 115 (e.g., one or more memory chips, stacked memory, etc.), which may include random access memory (RAM), read-only memory (ROM), or other state preserving media, as examples. Processor 110 may be coupled to storage device 120 (e.g., one or more storage devices), and to network connector 210, which may be, for example, an Ethernet connector or a wireless connector. Processor 110 may be connected to bus 215 (e.g., one or more buses), to which may be attached user interface 220 (e.g., one or more user interfaces) and Input/Output (I/O) interface ports that may be managed using I/O engine 225 (e.g., one or more I/O engines), among other components. As shown, processor 110 may be coupled to image editor 230, which may be an example of image editor 140 of FIG. 1. Additionally, or alternatively, processor 110 may be connected to bus 215, to which may be attached image editor 230.

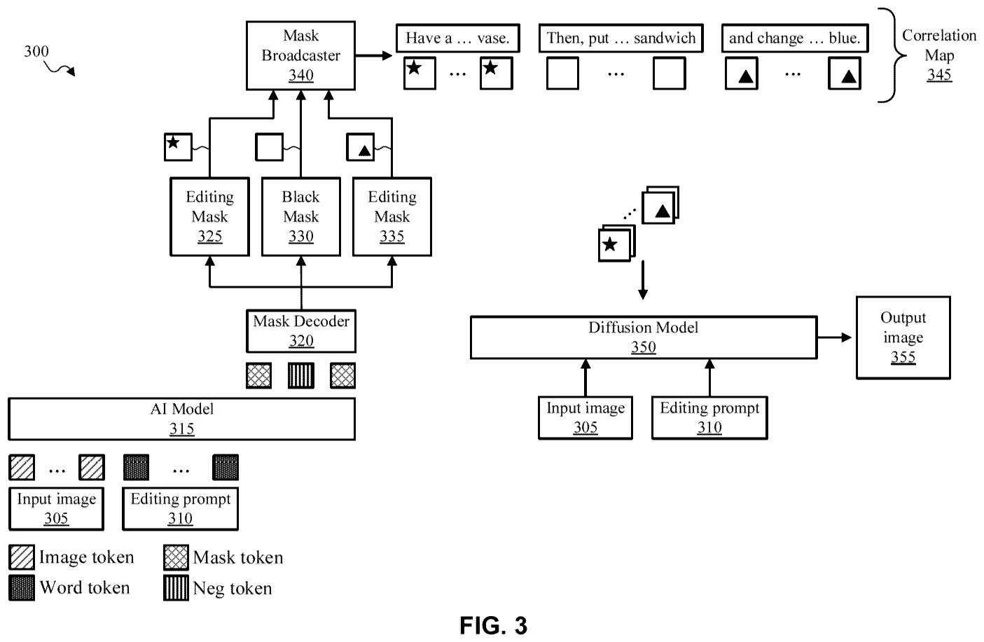

FIG. 3 illustrates an example system 300 in accordance with one or more implementations as described herein. In some configurations, one or more aspects of system 300 may be implemented by or in conjunction with image editor 140 of FIG. 1 and/or image editor 230 of FIG. 2. In some configurations, one or more aspects of system 300 may be implemented by or in conjunction with machine 105, components of machine 105, or any combination thereof.

In the illustrated example, system 300 may include input image 305, editing prompt 310, AI model 315 (e.g., LLM, multimodal LLM), mask decoder 320, editing mask 325, black mask 330, editing mask 335, mask broadcaster 340, correlation map 345 (e.g., broadcasted masks), diffusion model 350 (e.g., stable diffusion), and output image 355.

As shown, one or more image tokens may be generated from input image 305, and one or more word tokens may be generated from editing prompt 310. The image tokens and word tokens may be fed into AI model 315. AI model 315 may generate one or more mask tokens and/or one or more neg tokens based on analysis of the image tokens and word tokens. For example, AI model 315 may determine whether at least one of the word tokens is applicable to input image 305 based on analysis of the word tokens in relation to the image tokens. For example, AI model 315 may identify a correlation between one or more words of the editing prompt 310 (e.g., based on the word tokens) and one or more identified objects of input image 305 (e.g., based on the image tokens). For instance, AI model 315 may identify the word “vase” in editing prompt 310 (e.g., based on a word token for “vase”) and identify a vase in input image 305 (e.g., based an image token for the vase depicted in input image 305). Accordingly, AI model 315 may determine that an instruction associated with the word “vase” (e.g., “change color of vase to blue”) is applicable to the vase identified in input image 305. Accordingly, AI model 315 may include generating a mask token for the vase in the input image (e.g., a mask token that is a vector representation of masking portions of input image 305 and leaving the depicted vase unmasked).

In some examples, AI model 315 may determine no correlation exists between one or more words of editing prompt 310 (e.g., based on non-applicable word tokens) and the identified objects of input image 305 (e.g., based on the image tokens). For instance, AI model 315 may identify the word “sandwich” in editing prompt 310 (e.g., based on a word token for “sandwich”) and determine there is no sandwich in input image 305 (e.g., no image tokens matching a sandwich). Accordingly, AI model 315 may determine that an instruction associated with the word “sandwich” (e.g., “Then, put the rat next to the sandwich”) is not applicable to the objects identified in input image 305. Accordingly, AI model 315 may include generating a negative token (neg token) for the non-applicable instruction. As an example, editing prompt 310 may include “Have a squirrel be looking at the vase. Then, put the rat next to the sandwich, and change the color of the vase to blue.” AI model 315 may identify “Have a squirrel be looking at the vase” as a first instruction; identify “Then, put the rat next to the sandwich” as a second instruction; and identify “change the color of the vase to blue” as a third instruction. AI model 315 may identify a squirrel and vase in input image 305 based on the image tokens. Accordingly, AI model 315 may determine that the first instruction “Have a squirrel be looking at the vase” and third instruction “change the color of the vase to blue” are applicable to input image 305. Thus, AI model 315 may generate a first mask token for the first instruction and generate a second mask token for the third instruction. AI model 315 may determine that there is not rat or sandwich in input image 305 (e.g., no image tokens associated with a rat or a sandwich). Accordingly, AI model 315 may determine “Then, put the rat next to the sandwich” is not applicable to input image 305. Thus, AI model 315 may generate a neg token for the second instruction.

In the illustrated example, one or more mask tokens and/or one or more neg tokens generated by AI model 315 may be fed to mask decoder 320. In some cases, mask decoder 320 may process a mask token and generate an editing mask based on the mask token. Additionally, or alternatively, mask decoder 320 may process a neg token and generate a black mask based on the neg token. In the illustrated example, mask decoder may (a) generate editing mask 325 based on a first mask token (e.g., associated with a first instruction of editing prompt 310 applicable to input image 305); (b) generate black mask 330 based on a neg token (e.g., associated with a second instruction of editing prompt 310 that is not applicable to input image 305); and/or (c) generate editing mask 335 based on a second mask token (e.g., associated with a third instruction of editing prompt 310 applicable to input image 305).

In some examples, mask decoder 320 may generate editing mask 325 for first instruction “Have a squirrel be looking at the vase,” where editing mask 325 masks a portion of input image 305, leaving a squirrel in input image 305 unmasked. Accordingly, the squirrel in input image 305 may be edited while leaving the masked portion unchanged. Mask decoder 320 may generate black mask 330 for second instruction “Then, put the rat next to the sandwich,” where the black mask 330 blanks out (e.g., completely covers, completely blocks) input image 305, and thus, any processing of input image 305 based on the non-applicable instruction results in no changes to input image 305. Mask decoder 320 may generate editing mask 335 for a third instruction “change the color of the vase to blue,” where editing mask 325 masks a portion of input image 305, leaving a vase in input image 305 unmasked. Accordingly, the vase in input image 305 may be edited while leaving the masked portion unchanged.

In the illustrated example, editing mask 325, black mask 330, and/or editing mask 335 may be fed to mask broadcaster 340. In some examples, mask broadcaster 340 may distribute masks to corresponding words. For example, mask broadcaster 340 may broadcast (e.g., distribute, associate, correlate, map) an editing mask to word tokens determined to be associated with the editing mask and/or broadcast a black mask to word tokens determined to be associated with the black mask.

As shown, mask broadcaster 340 may broadcast editing mask 325 to a first set of word tokens of editing prompt 310. Mask broadcaster 340 may broadcast black mask 330 to a second set of word tokens of editing prompt 310. Mask broadcaster 340 may broadcast editing mask 335 to a third set of word tokens of editing prompt 310. For example, mask broadcaster 340 may broadcast editing mask 325 to word tokens of the applicable first instruction “Have a squirrel be looking at the vase,” broadcast black mask 330 to word tokens of the non-applicable second instruction “Then, put the rat next to the sandwich,” and/or broadcast editing mask 335 to word tokens of the applicable third instruction “change the color of the vase to blue.” These mappings or correlations (e.g., broadcasted masks) may be referred to as correlation map 345. It is noted that broadcast editing mask 325 may broadcast masks to word tokens or word embeddings. For example, mask broadcaster 340 may broadcast editing mask 325 to a first set of word embeddings; broadcast blank mask 330 to a second set of word embeddings; and/or broadcast editing mask 335 to a third set of word embeddings.

It is noted that although an order of operations is depicted in the illustrated example, different orders of operation or different sequences of operation may be implemented with less or more operations, or the same number of operations. For example, in some cases, mask broadcaster 340 may receive one or more mask tokens and/or one or more neg tokens from AI model 315 and map the mask tokens and/or neg tokens to words of editing prompt 310. In some examples, mask decoder 320 and/or mask broadcaster 340 may receive one or more mask tokens and/or one or more neg tokens from AI model 315. In some cases, correlation map 345 may include a mapping between the one or more mask tokens and words of editing prompt 310, and/or include a mapping between the one or more neg tokens and words of editing prompt 310. In some cases, mask broadcaster 340 may map the one or more masks (e.g., editing mask 325, black mask 330, editing mask 335) to one or more words of editing prompt 310 based on the mappings between the one or more mask tokens and words of editing prompt 310, and/or mappings between the one or more neg tokens and words of editing prompt 310.

In the illustrated example, correlation map 345 may be fed to diffusion model 350. As shown, input image 305 and/or editing prompt 310 may be fed to diffusion model 350. Diffusion model 350 may perform one or more modifications of input image 305 based on editing prompt 310 and/or correlation map 345. For example, diffusion model 350 may modify input image 305 based on first instruction “Have a squirrel be looking at the vase” from editing prompt 310. For example, diffusion model 350 may apply editing mask 325 to input image 305 according to editing mask 325 being correlated to the word tokens of “Have a squirrel be looking at the vase” in correlation map 345. Editing mask 325 may mask one or more portions of input image 305 (e.g., portions without the squirrel) and leave at least one portion unmasked (e.g., portion with the squirrel; mask everything but the squirrel). Accordingly, diffusion model 350 may modify the unmasked portion of input image 305 (e.g., modify the squirrel), leaving the masked portions unchanged.

Additionally, or alternatively, diffusion model 350 may make no modification to input image 305 based on second instruction “Then, put the rat next to the sandwich” from editing prompt 310 based on the determination input image 305 does not include a rat or a sandwich. Thus, diffusion model 350 may apply black mask 330 to input image 305 according to editing mask 330 being correlated to the word tokens of “Then, put the rat next to the sandwich” in correlation map 345, resulting in no change to input image 305.

Additionally, or alternatively, diffusion model 350 may modify input image 305 based on third instruction “change the color of the vase to blue” from editing prompt 310. For example, diffusion model 350 may apply editing mask 325 to input image 305 according to editing mask 325 being correlated to the word tokens of “change the color of the vase to blue” in correlation map 345. Editing mask 325 may mask one or more portions of input image 305 (e.g., portions without the vase) and leave at least one portion unmasked (e.g., portion with the vase; mask everything but the vase). Accordingly, diffusion model 350 may modify the unmasked portion of input image 305 (e.g., modify the vase), leaving the masked portions unchanged.

Based on the modifications to input image 305 (e.g., making squirrel look at vase, changing color of vase to blue), diffusion model 350 may generate output image 355, which may be the modified version of input image 305.

It is noted that while FIG. 3 depicts an example of a multi-instruction editing prompt with two applicable instructions and one non-applicable instructions, system 300 may be implemented with a single instruction editing prompt that includes an applicable portion and/or a non-applicable portion. System 300 may be implemented with multi-instruction editing prompts that include one or more applicable instructions and/or one or more non-applicable instructions. In some cases, system 300 may generate one or more mask tokens, one or more neg tokens, one or more editing masks, and/or one or more black masks.

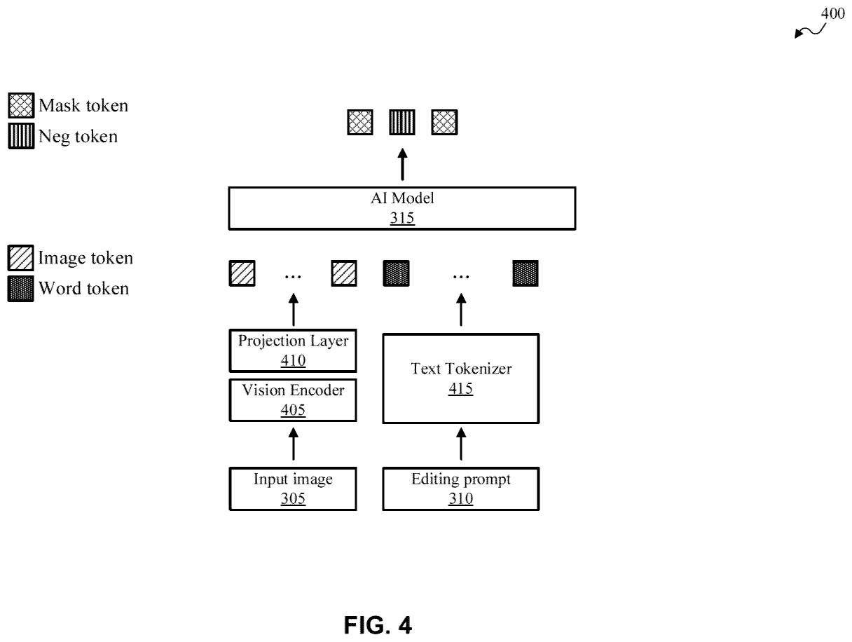

FIG. 4 illustrates an example system 400 in accordance with one or more implementations as described herein. In some configurations, one or more aspects of system 400 may be implemented by or in conjunction with image editor 140 of FIG. 1 and/or image editor 230 of FIG. 2. In some configurations, one or more aspects of system 400 may be implemented by or in conjunction with machine 105, components of machine 105, or any combination thereof.

As shown, system 400 may include input image 305, editing prompt 310, and AI model 315. Also, system 400 may include vision encoder 405, projection layer 410, and text tokenizer 415. In the illustrated example, vision encoder 405 may encode input image 305. Projection layer 410 may process the encoded input image 305 to generate image tokens. As shown, text tokenizer 415 may tokenize editing prompt 310 to generate word tokens. AI model 315 may receive the image tokens and/or word tokens and generate at least one mask token and/or at least one neg token.

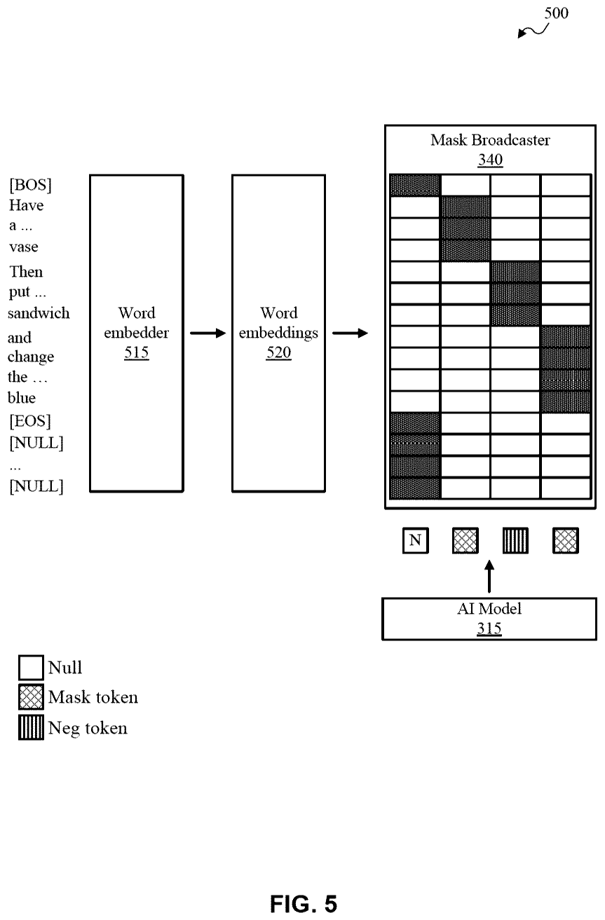

FIG. 5 illustrates an example system 500 in accordance with one or more implementations as described herein. In some configurations, one or more aspects of system 500 may be implemented by or in conjunction with image editor 140 of FIG. 1 and/or image editor 230 of FIG. 2. In some configurations, one or more aspects of system 500 may be implemented by or in conjunction with machine 105, components of machine 105, or any combination thereof.

In the illustrated example, system 500 may include AI model 315 and mask broadcaster 340. In some examples, AI model 315 may generate one or more mask tokens, one or more neg tokens, and/or at least one null token. As shown, AI model 315 may generate a first mask token for a first instruction from an editing prompt (e.g., editing prompt 310), a neg token for a second instruction from the editing prompt, and a second mask token for a third instruction from the editing prompt.

In the illustrated example, editing prompt 310 may be fed into word embedder 515. In some cases, word embedder 515 may generate embeddings based on editing prompt 310. As shown, word embedder 515 may generate word embeddings 520 (e.g., word embeddings of words from editing prompt 310).

In some examples, AI model 315 may generate one or more mask tokens and/or one or more neg tokens and provide the mask tokens and/or neg tokens to mask broadcaster 340. In the illustrated example, AI model 315 may provide a null token, a first mask token, a neg token, and a second mask token to mask broadcaster 340. As an example, AI model 315 may identify “Have a squirrel be looking at the vase” as a first instruction; identify “Then, put the rat next to the sandwich” as a second instruction; and identify “change the color of the vase to blue” as a third instruction from the editing prompt.

In some examples, mask broadcaster 340 may distribute tokens to corresponding words of the editing prompt. For example, mask broadcaster 340 may broadcast (e.g., distribute, associate, correlate, map) a mask token to one or more words (e.g., word tokens, word embeddings) determined to be associated with the mask token and/or broadcast a neg mask to words (e.g., word tokens, word embeddings) determined to be associated with the neg mask. In some cases, mask broadcaster 340 may perform matrix multiplication between word embeddings (e.g., word embeddings or word tokens) of the editing prompt and a mask token. In some cases, mask broadcaster 340 may perform matrix multiplication between word embeddings (e.g., word embeddings or word tokens) of the editing prompt and a neg token. The matrix multiplication may produce a similarity score that indicates whether a given word embedding/word token is related to the mask token, and/or whether a given word embedding/word token is related to the neg token.

In the illustrated example, mask broadcaster 340 may perform matrix multiplication between word embeddings of editing prompt 310 and a mask token associated with an instruction of editing prompt 310. In some cases, the dot product of a mask token and word embedding may represent the similarity between that word embedding and the mask token (e.g., indicating the word is associated with an applicable instruction of the mask token). In some cases, mask broadcaster 340 may perform matrix multiplication between word embeddings of editing prompt 310 and a neg token. In some cases, the dot product of a word embedding and a neg token may represent the similarity between that word embedding and the neg token (e.g., indicating the word is associated with a non-applicable instruction of the neg token).

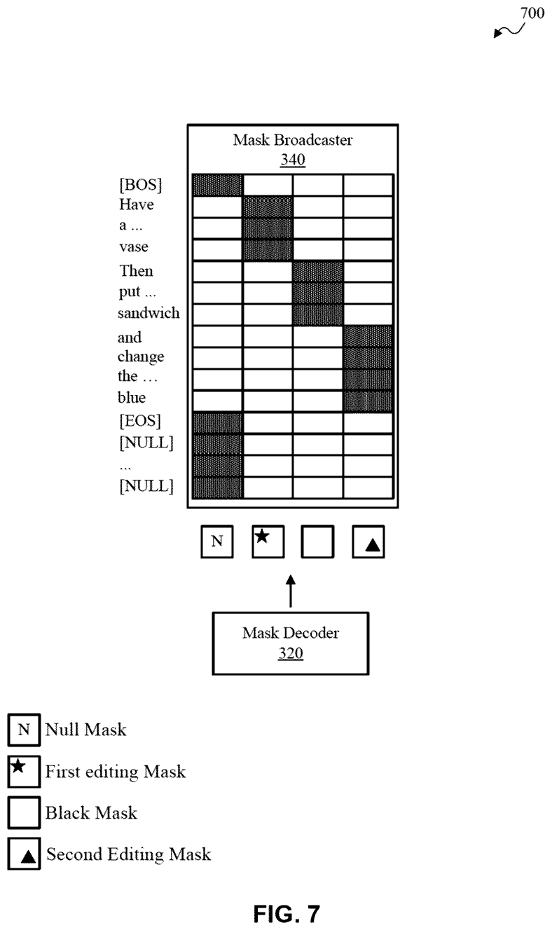

As shown, mask broadcaster 340 may associate a beginning of sentence marker [BOS] and end of sentence marker [EOS] with a null token. In some cases, mask broadcaster may include a set number of entries (e.g., number of vertical entries in FIG. 7). The number of entries may be set based on the number of words or number of characters allowed for a given query or editing prompt. When the number of words or characters in the editing prompt are less than the number allowed, then mask broadcaster 340 may map these unused entries to the null token.

As shown, mask broadcaster 340 may map a first set of one or more words (e.g., word tokens, word embeddings) of the editing prompt to a first mask token, map a second set of one or more words (e.g., word tokens, word embeddings) of the editing prompt to a neg token, and/or map a third set of one or more words (e.g., word tokens, word embeddings) of the editing prompt to a second mask token. Accordingly, mask broadcaster 340 may correlate a mask token to words of an editing instruction, where the words are part of an instruction for editing the input image, those words having been determined to be applicable to at least one object in the input image. Mask broadcaster 340 may correlate a neg token to words of an editing instruction, where the words are part of an instruction that is determined to be non-applicable to the input image (e.g., words that refer to objects not found in the input image).

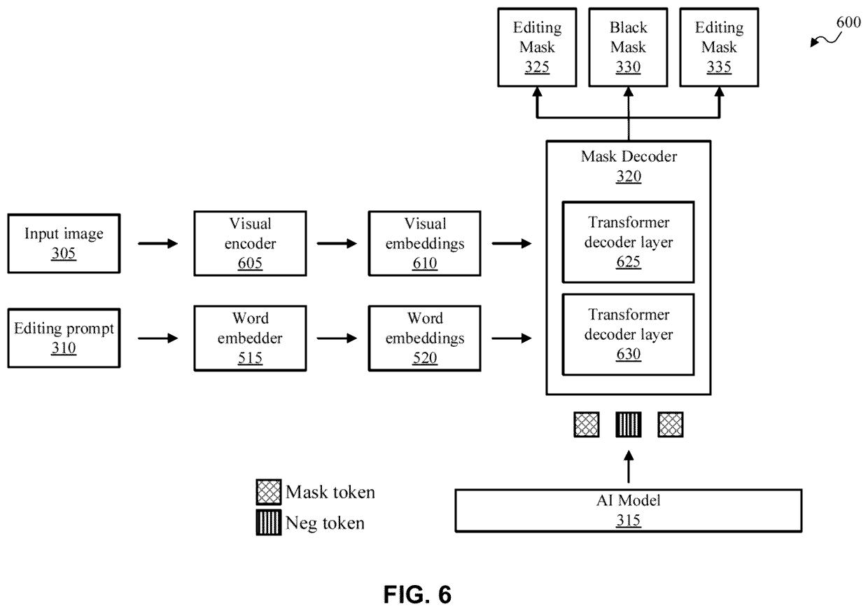

FIG. 6 illustrates an example system 600 in accordance with one or more implementations as described herein. In some configurations, one or more aspects of system 600 may be implemented by or in conjunction with image editor 140 of FIG. 1 and/or image editor 230 of FIG. 2. In some configurations, one or more aspects of system 600 may be implemented by or in conjunction with machine 105, components of machine 105, or any combination thereof.

As shown, system 600 may include input image 305, editing prompt 310, AI model 315, mask decoder 320, editing mask 325, black mask 330, and editing mask 335. As shown, mask decoder 320 may include transformer decoder layer 625 and transformer decoder layer 630. Editing mask 325 may be based on a first mask token associated with a first portion of editing prompt 310, black mask 330 may be based on a neg token associated with a second portion of editing prompt 310, and editing mask 335 may be based on a second mask token associated with a third portion of editing prompt 310.

In the illustrated example, input image 305 may be fed into visual encoder 605. In some cases, visual encoder 605 may be an example of vision encoder 405. Visual encoder 605 may encode input image 305. In some cases, visual encoder 605 may encode image patches of input image 305, where input image 305 is segmented into multiple image patches, which are encoded by visual encoder 605. As shown, visual encoder 605 may generate visual embeddings 610 (e.g., visual embeddings of input image 305).

In the illustrated example, editing prompt 310 may be fed into word embedder 515. In some cases, word embedder 515 may generate embeddings based on editing prompt 310. As shown, word embedder 515 may generate word embeddings 520 (e.g., word embeddings of words from editing prompt 310).

In the illustrated example, mask decoder 320 may receive visual embeddings 610 and word embeddings 520. As shown, mask decoder 320 may receive one or more mask tokens and/or one or more neg tokens from AI model 315. Mask decoder 320 may generate editing maps and/or black masks based on the inputs to mask decoder 320 (e.g., visual embeddings 610, word embeddings 520, mask tokens, neg tokens). In some cases, mask decoder 320 may include one or more transformer decoder layers.

In the illustrated example, visual embeddings 610 may be fed into transformer decoder layer 625 and word embeddings 520 may be fed into transformer decoder layer 630. In some examples,

In some cases, transformer decoder layer 625 may be configured as an image transformer decoder layer and transformer decoder layer 630 may be configured as a text transformer decoder layer. Accordingly, transformer decoder layer 625 may decode visual embeddings 610 relative to one or more mask tokens and/or one or more neg tokens and transformer decoder layer 630 may decode word embeddings 520 relative to the one or more mask tokens and/or one or more neg tokens. In some cases, mask decoder 320 may output an editing mask for each received mask token and/or output a black mask for each received neg token. In the illustrated example, AI model 315 may generate a first mask token based on a first applicable instruction from editing prompt 310, generate a neg token based on a non-applicable instruction from editing prompt 310, and generate a second mask token based on a second applicable instruction from editing prompt 310. Thus, mask decoder 320 may output editing mask 325 based on the first mask token, output black mask 330 based on the neg token, and output editing mask 335 based on the second mask token.

FIG. 7 illustrates an example system 700 in accordance with one or more implementations as described herein. In some configurations, one or more aspects of system 700 may be implemented by or in conjunction with image editor 140 of FIG. 1 and/or image editor 230 of FIG. 2. In some configurations, one or more aspects of system 700 may be implemented by or in conjunction with machine 105, components of machine 105, or any combination thereof.

In the illustrated example, mask decoder 320 may generate one or more masks and provide the masks to mask broadcaster 340. In some examples, mask decoder 320 may provide a null mask, an editing mask, and/or a black mask. As shown, mask decoder 320 may provide a null mask, a first editing mask, a black mask, and a second editing mask to mask broadcaster 340.

In the illustrated example, an AI model (e.g., AI model 315, a multimodal LLM AI model) may identify “Have a squirrel be looking at the vase” as a first instruction; identify “Then, put the rat next to the sandwich” as a second instruction; and identify “change the color of the vase to blue” as a third instruction from an editing prompt.

In some examples, mask broadcaster 340 may distribute masks to corresponding words of the editing prompt (e.g., editing prompt 310). For example, mask broadcaster 340 may broadcast (e.g., distribute, associate, correlate, map) an editing mask to word tokens determined to be associated with the editing mask and/or broadcast a black mask to word tokens determined to be associated with the black mask. In some cases, mask broadcaster 340 may perform matrix multiplication between word embeddings or word tokens of an editing prompt and a mask token. In some cases, mask broadcaster 340 may perform matrix multiplication between word embeddings or word tokens of an editing prompt and a neg token. The matrix multiplication may produce a similarity score that indicates whether the word embedding or word token is related to the mask token, or whether the word embedding or word token is related to the neg token, respectively.

In the illustrated example, mask broadcaster 340 may perform matrix multiplication between word embeddings or word tokens of editing prompt 310 and a mask token. In some cases, the dot product of a mask token and word embedding or word tokens may represent the similarity between that word embedding or word tokens and the mask token (e.g., indicating the word is associated with an applicable instruction of the mask token). In some cases, mask broadcaster 340 may perform matrix multiplication between word embeddings or word tokens of editing prompt 310 and a neg token. In some cases, the dot product of a word embedding or word token and a neg token may represent the similarity between that word embedding or word token and the neg token (e.g., indicating the word is associated with a non-applicable instruction of the neg token).

As shown, mask broadcaster 340 may associate a beginning of sentence marker [BOS] and end of sentence marker [EOS] with a null mask. In some cases, mask broadcaster may include a set number of entries (e.g., number of vertical entries in FIG. 7). The number of entries may be set based on the number of words or number of characters allowed for a given query or editing prompt. When the number of words or characters in the editing prompt are less than the number allowed, then mask broadcaster 340 may map these unused entries to the null mask.

As shown, mask broadcaster 340 may map a first set of one or more words (e.g., word tokens, word embeddings) of the editing prompt to a first editing mask (e.g., editing mask 325), map a second set of one or more words (e.g., word tokens, word embeddings) of the editing prompt to a black mask (e.g., black mask 330), and/or map a third set of one or more words (e.g., word tokens, word embeddings) of the editing prompt to a second editing mask (e.g., editing mask 335). Accordingly, mask broadcaster 340 may correlate an editing mask to words of an editing instruction, where the words are part of an instruction for editing the input image, those words having been determined to be applicable to objects in the input image. Mask broadcaster 340 may correlate a black mask to words of an editing instruction, where the words are part of an instruction that is determined to be non-applicable to the input image (e.g., words that refer to objects not found in the input image).

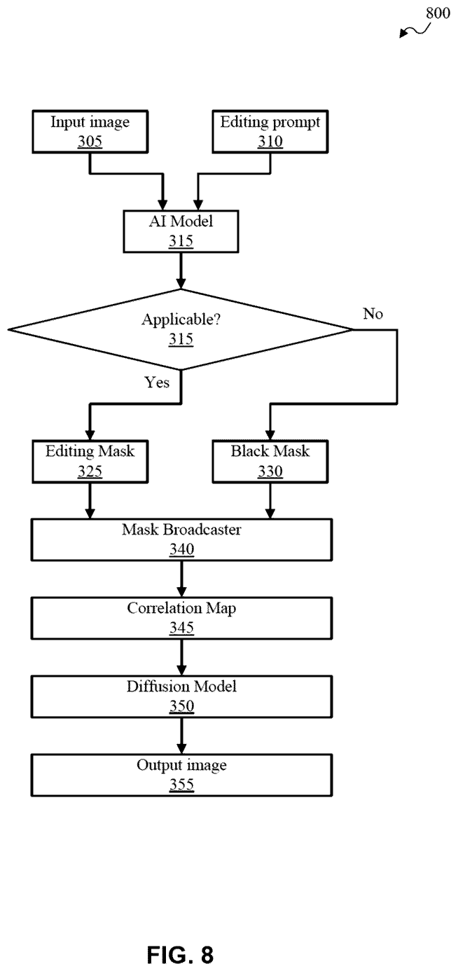

FIG. 8 depicts a flow diagram illustrating an example method 800 associated with the disclosed systems, in accordance with example implementations described herein. In some configurations, one or more aspects of method 800 may be implemented by or in conjunction with image editor 140 of FIG. 1 and/or image editor 230 of FIG. 2. In some configurations, one or more aspects of method 800 may be implemented by or in conjunction with machine 105, components of machine 105, or any combination thereof. The depicted method 800 is just one implementation and one or more operations of method 800 may be rearranged, reordered, omitted, and/or otherwise modified such that other implementations are possible and contemplated.

As shown, method 800 may include AI model 315 receiving input image 305 and editing prompt 310. In some examples, AI model 315 may determine whether editing prompt 310 includes at least one instruction that is applicable to input image 305. In some cases, AI model 315 may provide one or more mask tokens and/or one or more neg tokens to a mask decoder.

As shown, method 800 may include a mask decoder generating editing mask 325 for an instruction from editing prompt 310 that is determined to be applicable to input image 305. As shown, method 800 may include the mask decoder generating black mask 330 for an instruction from editing prompt 310 that is determined to be non-applicable to input image 305.

As shown, method 800 may include mask broadcaster 340 receiving editing mask 325 and black mask 330.

As shown, method 800 may include mask broadcaster 340 generating correlation map 345 (e.g., broadcasted masks) based on an analysis of editing mask 325 and/or black mask 330. In some cases, correlation map 345 may map editing mask 325 to a first set of one or more words of editing prompt 310 and/or map black mask 330 to a second set of one or more words of editing prompt 310.

As shown, method 800 may include diffusion model 350 receiving correlation map 345. In some cases, diffusion model 350 may generate output image 355 based on analysis of correlation map 345, where output image 355 may be a modified version of input image 305.

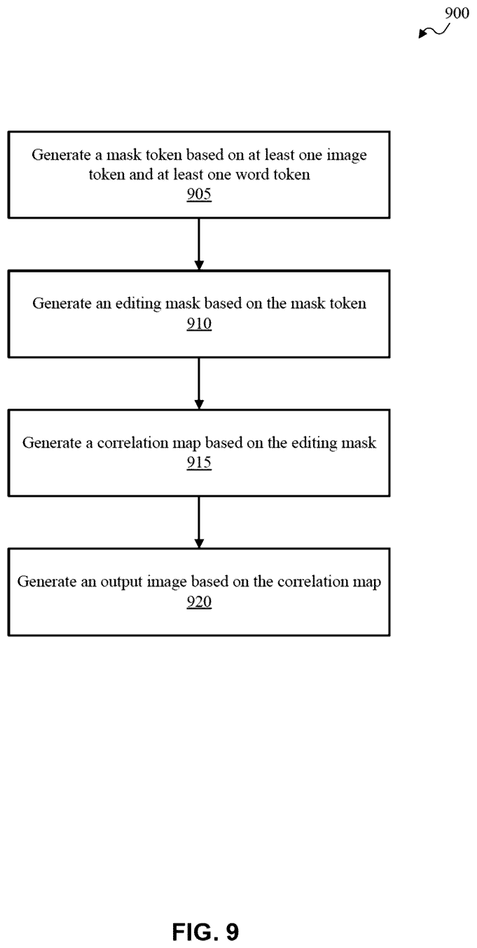

FIG. 9 depicts a flow diagram illustrating an example method 900 associated with the disclosed systems, in accordance with example implementations described herein. In some configurations, one or more aspects of method 900 may be implemented by or in conjunction with image editor 140 of FIG. 1 and/or image editor 230 of FIG. 2. In some configurations, one or more aspects of method 900 may be implemented by or in conjunction with machine 105, components of machine 105, or any combination thereof. The depicted method 900 is just one implementation and one or more operations of method 900 may be rearranged, reordered, omitted, and/or otherwise modified such that other implementations are possible and contemplated.

At 905, method 900 may include generating a mask token based on at least one image token and at least one word token. For example, method 900 may include generating image tokens from an input image and word tokens from an editing prompt, and generating a mask token based on an artificial intelligence model (e.g., LLM, multimodal LLM) processing the image tokens and the word tokens.

At 910, method 900 may include generating an editing mask based on the mask token. For example, method 900 may include a word embedder generating word embeddings from the editing prompt and a visual encoder generating visual embeddings from the input image. Method 900 may include generating an editing mask based on a mask decoder processing the mask token, the word embeddings, and the visual embeddings.

At 915, method 900 may include generating a correlation map that correlates the editing mask to a set of one or more words of the editing prompt. For example, method 900 may include determining the editing mask applies to a first word of the editing prompt and does not apply to a second word of the editing prompt. Accordingly, the editing mask may be correlated or mapped to the first word and not correlated or mapped to the second word, etc.

At 920, method 900 may include generating an output image based on the correlation map. For example, method 900 may include applying the editing mask to the input image (e.g., masking out a portion of the input image not being edited), editing a portion of the input image based on applying the editing mask, and generating the output image based on editing the portion of the input image. The correlation map may indicate how the portion of the input image is edited based on the text of the editing prompt mapped to the editing mask. Accordingly, method 900 may include generating an output image based on the correlation map, where the output image includes an edited version of the input image according to the editing prompt.

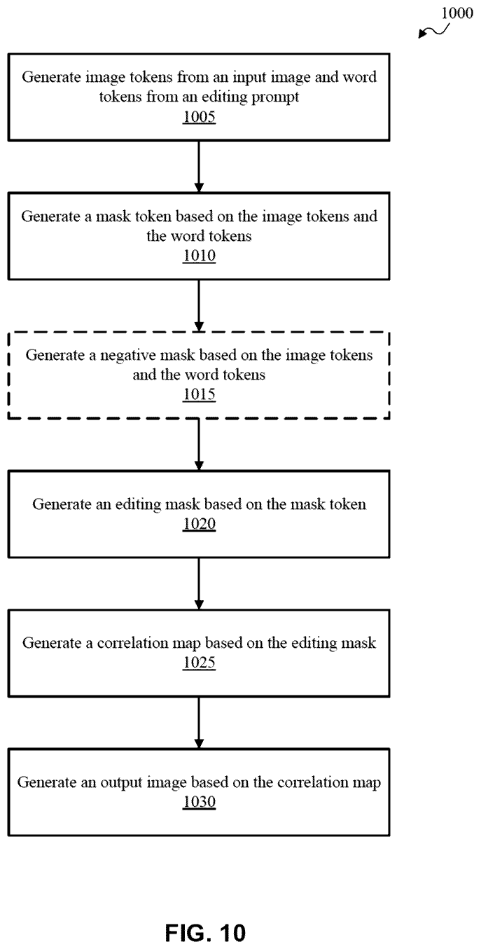

FIG. 10 depicts a flow diagram illustrating an example method 1000 associated with the disclosed systems, in accordance with example implementations described herein. In some configurations, one or more aspects of method 1000 may be implemented by or in conjunction with image editor 140 of FIG. 1 and/or image editor 230 of FIG. 2. In some configurations, one or more aspects of method 1000 may be implemented by or in conjunction with machine 105, components of machine 105, or any combination thereof. The depicted method 1000 is just one implementation and one or more operations of method 1000 may be rearranged, reordered, omitted, and/or otherwise modified such that other implementations are possible and contemplated.

At 1005, method 1000 may include generating image tokens from an input image and word tokens from an editing prompt. For example, a text tokenizer may generate the word tokens from the editing prompt, and a vision encoder (e.g., and projection layer) may generate the image tokens.

At 1010, method 1000 may include generating a mask token based on the image tokens and the word tokens. For example, method 1000 may include generating a mask token based on an artificial intelligence model (e.g., LLM, multimodal LLM) processing the image tokens and the word tokens. For example, method 1000 may include identifying a correlation between one or more words of the editing prompt (e.g., word tokens) and one or more identified objects of the input image (e.g., image tokens). For instance, method 1000 may include identifying the word “vase” in the editing prompt and identifying a vase in the input image. Accordingly, method 1000 may determine that an instruction associated with the word “vase” (e.g., “change color of vase to blue”) is applicable to the vase identified in the input image. Accordingly, method 1000 may include generating a mask token for the vase in the input image.

At 1015, method 1000 may optionally include generating a negative mask based on the image tokens and the word tokens. For example, method 1000 may include determining no correlation exists between one or more words of the editing prompt (e.g., word tokens) and the identified objects of the input image (e.g., image tokens). For instance, method 1000 may include identifying the word “sandwich” in the editing prompt and determining there is no sandwich in the input image. Accordingly, method 1000 may determine that an instruction associated with the word “sandwich” (e.g., “Then, put the rat next to the sandwich”) is not applicable to the objects identified in the input image. Accordingly, method 1000 may include generating a negative token for the non-applicable instruction. In some cases, the method 1000 may include generating a black mask based on the negative token, where the black mask blanks out (e.g., completely covers, completely blocks) the input image, and thus, any processing of the input image based on the non-applicable instruction results in no changes to the input image.

At 1020, method 1000 may include generating an editing mask based on the mask token. For example, method 1000 may include a word embedder generating word embeddings from the editing prompt and a visual encoder generating visual embeddings from the input image. Method 1000 may include generating an editing mask based on a mask decoder processing the mask token, the word embeddings, and the visual embeddings.

At 1025, method 1000 may include generating a correlation map that correlates the editing mask to a set of one or more words of the editing prompt. For example, method 1000 may include determining the editing mask applies to a first word of the editing prompt and does not apply to a second word of the editing prompt. Accordingly, the editing mask may be correlated or mapped to the first word and not correlated or mapped to the second word, etc.

At 1030, method 1000 may include generating an output image based on the correlation map. For example, method 1000 may include applying the editing mask to the input image (e.g., masking out a portion of the input image not being edited), editing a portion of the input image based on applying the editing mask, and generating the output image based on editing the portion of the input image. The correlation map may indicate how the portion of the input image is edited based on the text of the editing prompt mapped to the editing mask. Accordingly, method 1000 may include generating an output image based on the correlation map, where the output image includes an edited version of the input image according to the editing prompt.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wired and/or wireless communication device such as a switch, router, network interface controller, cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be wireless, wired, mobile, and/or stationary.

As used within this document, the term “communicate” is intended to include transmitting, or receiving, or both transmitting and receiving. Similarly, the bidirectional exchange of data between two devices (both devices transmit and receive during the exchange) may be described as ‘communicating’, when only the functionality of one of those devices is being claimed. The term “communicating” as used herein with respect to wired and/or wireless communication signals includes transmitting the wired and/or wireless communication signals and/or receiving the wired and/or wireless communication signals. For example, a communication unit, which is capable of communicating wired and/or wireless communication signals, may include a wired/wireless transmitter to transmit communication signals to at least one other communication unit, and/or a wired/wireless communication receiver to receive the communication signal from at least one other communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBcc™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example an FPGA (field programmable gate array) or an ASIC (application-specific integrated circuit). The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example a CRT (cathode ray tube) or LCD (liquid crystal display) monitor, for displaying information/data to the user and a keyboard and a pointing device, for example a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example as an information/data server, or that includes a middleware component, for example an application server, or that includes a front-end component, for example a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example an HTML page) to a client device (for example for purposes of displaying information/data to and receiving user input from a user interacting with the client device). Information/data generated at the client device (for example a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other examples as set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method of image editing comprising:
generating image tokens from an input image and word tokens from an editing prompt;
generating a mask token based on an artificial intelligence model processing the image tokens and the word tokens;
generating an editing mask based on a mask decoder processing the mask token, word embeddings of the editing prompt, and visual embeddings of the input image;
generating a correlation map that correlates the editing mask to a set of one or more words of the editing prompt; and
generating an output image based on the correlation map, the output image comprising an edited version of the input image according to the editing prompt.

2. The method of claim 1, wherein the mask token is generated based on the artificial intelligence model determining the set of one or more words of the editing prompt are applicable to the input image based on at least one of the image tokens correlating to at least one of the word tokens.

3. The method of claim 1, wherein generating the editing mask is based on feeding the word embeddings to a first transformer decoder layer of the mask decoder and feeding the visual embeddings to a second transformer decoder layer of the mask decoder, the mask decoder being trained to generate the editing mask based on the mask decoder processing the mask token, word embeddings of the editing prompt, and visual embeddings of the input image.

4. The method of claim 1, wherein generating the correlation map is based on matrix multiplication between the mask token and the word embeddings.

5. The method of claim 1, further comprising generating a negative token based on the artificial intelligence model processing the image tokens and the word tokens.

6. The method of claim 5, wherein the negative token is generated based on the artificial intelligence model determining a second set of one or more words of the editing prompt are not applicable to the input image based on matrix multiplication between the negative token and the word embeddings.

7. The method of claim 6, further comprising generating a black mask based on the mask decoder processing the negative token, the word embeddings of the editing prompt, and the visual embeddings of the input image.

8. The method of claim 7, wherein:
the correlation map correlates the black mask to the second set of one or more words of the editing prompt, and
applying the black mask results in no changes to the input image.

9. The method of claim 1, wherein a word embedder generates the word embeddings from the editing prompt and a visual encoder generates the visual embeddings from the input image.

10. The method of claim 1, wherein a diffusion model generates the output image based on the diffusion model processing the correlation map, the input image, and the editing prompt.

11. The method of claim 1, wherein the artificial intelligence model comprises a multimodal large language model.

12. A device comprising:
one or more processors; and
memory storing instructions that, when executed by the one or more processors, cause the device to:
generate image tokens from an input image and word tokens from an editing prompt;
generate a mask token based on an artificial intelligence model processing the image tokens and the word tokens;
generate an editing mask based on a mask decoder processing the mask token, word embeddings of the editing prompt, and visual embeddings of the input image;
generate a correlation map that correlates the editing mask to a set of one or more words of the editing prompt; and
generate an output image based on the correlation map, the output image comprising an edited version of the input image according to the editing prompt.

13. The device of claim 12, wherein the mask token is generated based on the artificial intelligence model determining the set of one or more words of the editing prompt are applicable to the input image based on at least one of the image tokens correlating to at least one of the word tokens.

14. The device of claim 12, wherein generating the editing mask is based on feeding the word embeddings to a first transformer decoder layer of the mask decoder and feeding the visual embeddings to a second transformer decoder layer of the mask decoder, the mask decoder being trained to generate the editing mask based on the mask decoder processing the mask token, word embeddings of the editing prompt, and visual embeddings of the input image.

15. The device of claim 12, wherein generating the correlation map is based on matrix multiplication between the mask token and the word embeddings.

16. The device of claim 12, wherein the instructions, when executed by the one or more processors, further cause the device to generate a negative token based on the artificial intelligence model processing the image tokens and the word tokens, the negative token being generated based on the artificial intelligence model determining a second set of one or more words of the editing prompt are not applicable to the input image based on matrix multiplication between the negative token and the word embeddings.

17. The device of claim 16, wherein the instructions, when executed by the one or more processors, further cause the device to generate a black mask based on the mask decoder processing the negative token, the word embeddings of the editing prompt, and the visual embeddings of the input image.

18. A non-transitory computer-readable medium storing code that comprises instructions executable by a processor to:
generate image tokens from an input image and word tokens from an editing prompt;
generate a mask token based on an artificial intelligence model processing the image tokens and the word tokens;
generate an editing mask based on a mask decoder processing the mask token, word embeddings of the editing prompt, and visual embeddings of the input image;
generate a correlation map that correlates the editing mask to a set of one or more words of the editing prompt; and
generate an output image based on the correlation map, the output image comprising an edited version of the input image according to the editing prompt.

19. The non-transitory computer-readable medium of claim 18, wherein the mask token is generated based on the artificial intelligence model determining the set of one or more words of the editing prompt are applicable to the input image based on at least one of the image tokens correlating to at least one of the word tokens.

20. The non-transitory computer-readable medium of claim 18, wherein generating the editing mask is based on feeding the word embeddings to a first transformer decoder layer of the mask decoder and feeding the visual embeddings to a second transformer decoder layer of the mask decoder, the mask decoder being trained to generate the editing mask based on the mask decoder processing the mask token, word embeddings of the editing prompt, and visual embeddings of the input image.
